(19) United States
(12) Patent Application Publication
(10) Pub. No.: US 2023/0267352 A1
(43) Pub. Date: Aug. 24, 2023

(54) System, Method, and Computer Program Product for Time Series Based Machine Learning Model Reduction Strategy

(71) Applicant: Visa International Service Association, San Francisco, CA (US)

(72) Inventors: Runxin He, Austin, TX (US); Qingguo Chen, Round Rock, TX (US); Subir Roy, Austin, TX (US); Yu Gu, Austin, TX (US); Dan Wang, Austin, TX (US)

(21) Appl. No.: 17/677,159

(22) Filed: Feb. 22, 2022

(51) Int. Cl. G06N 7/00; G06F 17/16

(52) U.S. Cl. CPC G06N 7/005; G06F 17/16

(57) ABSTRACT

Provided are systems for generating a machine learning model and a prediction based on encoded time series data using model reduction techniques that include a processor to receive a training dataset of a plurality of data instances, wherein each data instance includes a time series of data points, perform an encoding operation on the training dataset to provide an encoded dataset having a lower dimension space than a dimension space of the training dataset, generate one or more prediction models based on the encoded dataset, determine an output of the one or more prediction models in the lower dimension space based on an input provided to the one or more prediction models, and perform a decoding operation on the output to project the output from the lower dimension space to the dimension space of the training dataset. Methods and computer program products are also provided.

### BACKGROUND

### 1. Field

This disclosure relates generally to machine learning and, in some non-limiting embodiments or aspects, to systems, methods, and computer program products for generating a machine learning model and a prediction based on encoded time series data using model reduction techniques.

### 2. Technical Considerations

Machine learning may refer to a field of computer science that uses statistical techniques to provide a computer system with the ability to learn (e.g., to progressively improve performance of) a task with data without the computer system being explicitly programmed to perform the task. In some instances, a machine learning model may be developed for a set of data so that the machine learning model may perform a task (e.g., a task associated with a prediction) with regard to the set of data.

In some instances, a machine learning model, such as a predictive machine learning model, may be used to make a prediction regarding a risk or an opportunity based on a large amount of data (e.g., a large scale dataset). A predictive machine learning model may be used to analyze a relationship between the performance of a unit based on a large scale dataset associated with the unit and one or more known features of the unit. The objective of the predictive machine learning model may be to assess the likelihood that a similar unit will exhibit the same or similar performance as the unit. In order to generate the predictive machine learning model, the large scale dataset may be segmented so that the predictive machine learning model may be trained on data that is appropriate.

A time series is a series of data points and/or data vectors indexed in time order. For example, a time series is a sequence of data points and/or data vectors recorded at successive, discrete points in time. In some instances, machine learning models may be used in time series forecasting. Time series forecasting includes using a model to predict future data points based on a previously recorded time series data.

In some instances, a plurality of models may be trained on a data pool of time series data and the plurality of models may be used to forecast events, based on a specific task (e.g., specific application) in different locations (e.g., regions). Each model of the plurality of models may be assigned to a specific location and each of the models may be trained separately, using a portion of the data pool (e.g., a portion of the data pool corresponding to the specific location assigned to a model). However, training each model separately may require a large amount of data and this may require a larger amount of computational resources than if the models were trained together. Additionally, separately training each model may require unnecessary preprocessing of a dataset. Further, separately trained models may be sensitive to missing data and noise where the data used for training each model is only a portion of the total data pool. In some instances, separately trained models trained on a portion of the data pool may result in the overfitting of each model to the portion of the data pool the model was trained on. This may result in inaccurate time series predictions.

### SUMMARY

Accordingly, disclosed are systems, methods, and computer program products for generating a machine learning model and a prediction based on encoded time series data using model reduction techniques.

According to some non-limiting embodiments or aspects, provided is a system for generating a machine learning model based on encoded time series data using model reduction techniques. The system includes at least one processor programmed and/or configured to receive a training dataset of a plurality of data instances, wherein each data instance comprises a time series of data points. The at least one processor is also programmed and/or configured to perform an encoding operation on the training dataset to provide an encoded dataset having a lower dimension space than a dimension space of the training dataset. The at least one processor is further programmed and/or configured to generate one or more prediction models based on the encoded dataset, wherein the one or more prediction models are configured to provide an output in the lower dimension space. The at least one processor is further programmed and/or configured to determine an output of the one or more prediction models in the lower dimension space based on an input provided to the one or more prediction models. The at least one processor is further programmed and/or configured to perform a decoding operation on the output to project the output from the lower dimension space to the dimension space of the training dataset.

According to some non-limiting embodiments or aspects, provided is a computer-implemented method for generating a machine learning model based on encoded time series data using model reduction techniques. The method includes receiving a training dataset of a plurality of data instances, wherein each data instance comprises a time series of data points. The method also includes performing an encoding operation on the training dataset to provide an encoded dataset having a lower dimension space than a dimension space of the training dataset. The method further includes generating one or more prediction models based on the encoded dataset, wherein the one or more prediction models are configured to provide an output in the lower dimension space. The method further includes determining an output of the one or more prediction models in the lower dimension space based on an input provided to the one or more prediction models. The method further includes performing a decoding operation on the output to project the output from the lower dimension space to the dimension space of the training dataset.

According to some non-limiting embodiments or aspects, provided is a computer program product for generating a machine learning model based on encoded time series data using model reduction techniques. The computer program product includes at least one non-transitory computer-readable medium including one or more instructions that, when executed by at least one processor, cause the at least one processor to receive a training dataset of a plurality of data instances, wherein each data instance comprises a time series of data points. The one or more instructions also cause the at least one processor to perform an encoding operation on the training dataset to provide an encoded dataset having a lower dimension space than a dimension space of the training dataset. The one or more instructions further cause the at least one processor to generate one or more prediction models based on the encoded dataset, wherein the one or more prediction models are configured to provide an output in the lower dimension space. The one or more instructions further cause the at least one processor to determine an output of the one or more prediction models in the lower dimension space based on an input provided to the one or more prediction models. The one or more instructions further cause the at least one processor to perform a decoding operation on the output to project the output from the lower dimension space to the dimension space of the training dataset.

Further embodiments are set forth in the following numbered clauses:

Clause 1: A system for generating a machine learning model based on encoded time series data using model reduction techniques, the system comprising: at least one processor programmed or configured to: receive a training dataset of a plurality of data instances, wherein each data instance comprises a time series of data points; perform an encoding operation on the training dataset to provide an encoded dataset having a lower dimension space than a dimension space of the training dataset; generate one or more prediction models based on the encoded dataset, wherein the one or more prediction models are configured to provide an output in the lower dimension space; determine an output of the one or more prediction models in the lower dimension space based on an input provided to the one or more prediction models; and perform a decoding operation on the output to project the output from the lower dimension space to the dimension space of the training dataset.

Clause 2: The system of clause 1, wherein, when generating the one or more prediction models based on the encoded dataset, the at least one processor is programmed or configured to: train the one or more prediction models in the lower dimension space based on the encoded dataset.

Clause 3: The system of clauses 1 or 2, wherein, when performing the encoding operation on the dataset to provide the encoded dataset, the at least one processor is further programmed or configured to: perform a factorization operation based on an optimization problem, wherein the optimization problem is the following:

$${min}_{F , X , W} {\sum }_{( i , i ) ∈ Ω} {( {Y}_{it} - {f}_{i}^{T} {x}_{i} )}^{2} + {λ}_{f} {ℛ}_{f} ( F ) + {\sum }_{r = 1}^{k} {λ}_{x} {𝒯}_{AR} ( {\overline{x}}_{r} \vert ℒ , {\overline{ω}}_{r} , η ) + {λ}_{w} {ℛ}_{w} ( W ) ,$$

$$wherein :$$

$${λ}_{x} {𝒯}_{AR} ( {\overline{x}}_{r} \vert ℒ , {\overline{ω}}_{r} , η ) = \frac{1}{2} {\sum }_{t = m}^{T} {( {x}_{l} - {\sum }_{l ∈ ℒ} {w}_{l} {x}_{t - l} )}^{2} + \frac{η}{2} {‖ \overline{x} ‖}^{2} ,$$

and wherein: xₜ= [symbol] W^{(l)}xₜ₋ₗ+ϵₜ wherein Yᵢₜ is the training dataset, i is an i-th observation target, t is a time stamp of each data point of the time series of data points, F is a projection matrix, fᵢ^{T} is a translation to an i-th row of the projection matrix F, X is the encoded dataset having a lower dimension space, xₜ is a data point of the time series of data points, k is a first dimension of the encoded dataset X, [symbol] _{f}(F) is a squared Frobenius norm of the projection matrix F, λ_{f} is a weight of the projection matrix F, W is an auto-regression model, [symbol] _{w}(W) is a squared Frobenius norm of the auto-regression model W, λ_{w} is a weight of the auto-regression model W, [symbol] is a score of the auto-regression model W, λₓ is a weight of the score of the auto-regression model [symbol] , [symbol] is a second dimension of the encoded dataset X, w is a prediction model, η is a weight to a vector norm, l is an individual component of the second dimension [symbol] , T is a total time of the of the time series of data points, and ϵₜ is an error value associated with xₜ.

Clause 4: The system of any of clauses 1-3, wherein, when performing the factorization operation, the at least one processor is programmed or configured to: update the projection matrix F using a least square optimization problem; update the transferred low-dimensional space X using a graph-regularized alternating least squares (GRALS); and update the auto-regression model W by solving the following:

$$arg {min}_{{ω}^{\_}} {λ}_{x} {T}_{AR} ( {\overline{x}}_{r} \vert ℒ , \overline{w} , η ) + {λ}_{w} {‖ \overline{w} ‖}^{2} ≡ arg {min}_{{ω}^{\_}} {\sum }_{t = m}^{T} {( {x}_{l} - {\sum }_{l ∈ ℒ} {w}_{l} {x}_{t - l} )}^{2} + \frac{{λ}_{w}}{{λ}_{x}} {‖ \overline{w} ‖}^{2} .$$

Clause 5: The system of any of clauses 1-4, wherein, when performing the decoding operation on the output to project the output from the lower dimension space to the dimension space of the training dataset, the at least one processor is programmed or configured to: project the output from the lower dimension space to the dimension space of the training dataset using an inverse of the projection matrix F.

Clause 6: The system of any of clauses 1-5, wherein the lower dimension space has a first dimension and a second dimension, and wherein the dimension space of the training dataset has a first dimension and a second dimension, wherein the first dimension of the lower dimension space is less than the first dimension of the training dataset, and wherein the second dimension of the lower dimension space is equal to the second dimension of the training dataset.

Clause 7: The system of any of clauses 1-6, wherein the one or more prediction models comprise a number of prediction models, and wherein the number of prediction models is equal to the first dimension of the lower dimension space.

Clause 8: A method for generating a machine learning model based on encoded time series data using model reduction techniques, the method comprising: receiving, with at least one processor, a training dataset of a plurality of data instances, wherein each data instance comprises a time series of data points; performing, with at least one processor, an encoding operation on the training dataset to provide an encoded dataset having a lower dimension space than a dimension space of the training dataset; generating, with at least one processor, one or more prediction models based on the encoded dataset, wherein the one or more prediction models are configured to provide an output in the lower dimension space; determining, with at least one processor, an output of the one or more prediction models in the lower dimension space based on an input provided to the one or more prediction models; and performing, with at least one processor, a decoding operation on the output to project the output from the lower dimension space to the dimension space of the training dataset.

Clause 9: The method of clause 8, wherein generating the one or more prediction models based on the encoded dataset comprises: training the one or more prediction models in the lower dimension space based on the encoded dataset.

Clause 10: The method of clauses 8 or 9, wherein performing the encoding operation on the dataset to provide the encoded dataset comprises: performing a factorization operation based on an optimization problem, wherein the optimization problem is the following:

$${min}_{F , X , W} {\sum }_{( i , t ) ∈ Ω} {( {Y}_{it} - {f}_{i}^{T} {x}_{t} )}^{2} + {λ}_{f} {ℛ}_{f} ( F ) + {\sum }_{r = 1}^{k} {λ}_{x} {𝒯}_{AR} ( {\overline{x}}_{r} \vert ℒ , {\overline{𝓌}}_{r} , η ) + {λ}_{w} {ℛ}_{w} ( 𝒲 ) ,$$

$$wherein :$$

$${𝒯}_{AR} ( \overline{x} \vert ℒ , \overline{ω} , η ) = \frac{1}{2} {\sum }_{t = m}^{T} {( {x}_{t} - {\sum }_{l ∈ ℒ} {ω}_{l} {x}_{t - l} )}^{2} + \frac{η}{2} {‖ \overline{x} ‖}^{2} ,$$

and wherein: xₜ= [symbol] W^{(l)}xₜ₋ₗ+ϵₜ wherein Yᵢₜ is the training dataset, i is an i-th observation target, t is a time stamp of each data point of the time series of data points, F is a projection matrix, fᵢ^{T} is a translation to an i-th row of the projection matrix F, X is the encoded dataset having a lower dimension space, xₜ is a data point of the time series of data points, k is a first dimension of the encoded dataset X, [symbol] _{f}(F) is a squared Frobenius norm of the projection matrix F, λ_{f} is a weight of the projection matrix F, W is an auto-regression model, [symbol] _{w}(W) is a squared Frobenius norm of the auto-regression model W, λ_{w} is a weight of the auto-regression model W, [symbol] is a score of the auto-regression model W, λₓ is a weight of the score of the auto-regression model [symbol] , [symbol] is a second dimension of the encoded dataset X, w is a prediction model, η is a weight to a vector norm, l is an individual component of the second dimension [symbol] , T is a total time of the of the time series of data points, and ϵₜ is an error value associated with xₜ.

Clause 11: The method of any of clauses 8-10, wherein performing the factorization operation comprises: updating the projection matrix F using a least square optimization problem; updating the transferred low-dimensional space X using a graph-regularized alternating least squares (GRALS); and updating the auto-regression model W by solving the following:

$$arg {min}_{\overline{ω}} {λ}_{x} {𝒯}_{AR} ( {\overline{x}}_{r} \vert ℒ , \overline{ω} , η ) + {λ}_{w} {‖ \overline{ω} ‖}^{2} = arg {min}_{\overline{ω}} {\sum }_{t = m}^{T} {( {x}_{t} - {\sum }_{l ∈ ℒ} {ω}_{l} {x}_{t - l} )}^{2} + \frac{{λ}_{w}}{{λ}_{x}} {‖ \overline{ω} ‖}^{2} .$$

Clause 12: The method of any of clauses 8-11, wherein performing the decoding operation on the output to project the output from the lower dimension space to the dimension space of the training dataset comprises: projecting the output from the lower dimension space to the dimension space of the training dataset using an inverse of the projection matrix F.

Clause 13: The method of any of clauses 8-12, wherein the lower dimension space has a first dimension and a second dimension, and wherein the dimension space of the training dataset has a first dimension and a second dimension, wherein the first dimension of the lower dimension space is less than the first dimension of the training dataset, and wherein the second dimension of the lower dimension space is equal to the second dimension of the training dataset.

Clause 14: The method of any of clauses 8-13, wherein the one or more prediction models comprise a number of prediction models, and wherein the number of prediction models is equal to the first dimension of the lower dimension space.

Clause 15: A computer program product for generating a machine learning model based on encoded time series data using model reduction techniques, the computer program product comprising at least one non-transitory computer-readable medium including one or more instructions that, when executed by at least one processor, cause the at least one processor to: receive a training dataset of a plurality of data instances, wherein each data instance comprises a time series of data points; perform an encoding operation on the training dataset to provide an encoded dataset having a lower dimension space than a dimension space of the training dataset; generate one or more prediction models based on the encoded dataset, wherein the one or more prediction models are configured to provide an output in the lower dimension space; determine an output of the one or more prediction models in the lower dimension space based on an input provided to the one or more prediction models; and perform a decoding operation on the output to project the output from the lower dimension space to the dimension space of the training dataset.

Clause 16: The computer program product of clause 15, wherein the one or more instructions that cause the at least one processor to generate the one or more prediction models based on the encoded dataset cause the at least one processor to: train the one or more prediction models in the lower dimension space based on the encoded dataset.

Clause 17: The computer program product of clauses 15 or 16, wherein the one or more instructions that cause the at least one processor to perform the encoding operation on the dataset to provide the encoded dataset cause the at least one processor to: perform a factorization operation based on an optimization problem, wherein the optimization problem is the following:

$${min}_{F , X , W} {\sum }_{( i , t ) ∈ Ω} {( {Y}_{it} - {f}_{i}^{T} {x}_{t} )}^{2} + {λ}_{f} {ℛ}_{f} ( F ) + {\sum }_{r = 1}^{k} {λ}_{x} {𝒯}_{AR} ( {\overline{x}}_{r} \vert ℒ , {\overline{𝓌}}_{r} , η ) + {λ}_{w} {ℛ}_{w} ( 𝒲 ) ,$$

$$wherein :$$

$${𝒯}_{AR} ( \overline{x} \vert ℒ , \overline{ω} , η ) = \frac{1}{2} {\sum }_{t = m}^{T} {( {x}_{t} - {\sum }_{l ∈ ℒ} {ω}_{l} {x}_{t - l} )}^{2} + \frac{η}{2} {‖ \overline{x} ‖}^{2} ,$$

and wherein: xₜ= [symbol] W^{(l)}xₜ₋ₗ+ϵₜ wherein Yᵢₜ is the training dataset, i is an i-th observation target, t is a time stamp of each data point of the time series of data points, F is a projection matrix, fᵢ^{T} is a translation to an i-th row of the projection matrix F, X is the encoded dataset having a lower dimension space, xₜ is a data point of the time series of data points, k is a first dimension of the encoded dataset X, [symbol] _{f}(F) is a squared Frobenius norm of the projection matrix F, λ_{f} is a weight of the projection matrix F, W is an auto-regression model, [symbol] _{w}(W) is a squared Frobenius norm of the auto-regression model W, λ_{w} is a weight of the auto-regression model W, [symbol] is a score of the auto-regression model W, λₓ is a weight of the score of the auto-regression model [symbol] , [symbol] is a second dimension of the encoded dataset X, w is a prediction model, η is a weight to a vector norm, l is an individual component of the second dimension [symbol] , T is a total time of the of the time series of data points, and ϵₜ is an error value associated with xₜ.

Clause 18: The computer program product of any of clauses 15-17, wherein the one or more instructions that cause the at least one processor to perform the factorization operation cause the at least one processor to: update the projection matrix F using a least square optimization problem; update the transferred low-dimensional space X using a graph-regularized alternating least squares (GRALS); and update the auto-regression model W by solving the following:

$$arg {min}_{\overline{ω}} {λ}_{x} {𝒯}_{AR} ( {\overline{x}}_{r} \vert ℒ , \overline{ω} , η ) + {λ}_{w} {‖ \overline{ω} ‖}^{2} = arg {min}_{\overline{ω}} {\sum }_{t = m}^{T} {( {x}_{t} - {\sum }_{l ∈ ℒ} {ω}_{l} {x}_{t - l} )}^{2} + \frac{{λ}_{w}}{{λ}_{x}} {‖ \overline{ω} ‖}^{2} .$$

Clause 19: The computer program product of any of clauses 15-18, wherein the one or more instructions that cause the at least one processor to perform the decoding operation on the output to project the output from the lower dimension space to the dimension space of the training dataset cause the at least one processor to: project the output from the lower dimension space to the dimension space of the training dataset using an inverse of the projection matrix F.

Clause 20: The computer program product of any of clauses 15-19, wherein the lower dimension space has a first dimension and a second dimension, and wherein the dimension space of the training dataset has a first dimension and a second dimension, wherein the first dimension of the lower dimension space is less than the first dimension of the training dataset, and wherein the second dimension of the lower dimension space is equal to the second dimension of the training dataset.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the disclosed subject matter are explained in greater detail below with reference to the exemplary embodiments or aspects that are illustrated in the accompanying figures, in which:

FIG. 1 is a diagram of a non-limiting embodiment or aspect of an environment in which systems, devices, products, apparatus, and/or methods, described herein, may be implemented according to the principles of the present disclosure;

FIG. 2 is a diagram of a non-limiting embodiment or aspect of components of one or more devices and/or one or more systems of FIG. 1;

FIG. 3 is a flowchart of a non-limiting embodiment or aspect of a process for generating a machine learning model based on encoded time series data using model reduction techniques;

FIG. 4 is a flowchart of a non-limiting embodiment or aspect of a process for generating a prediction based on encoded time series data using model reduction techniques; and

FIGS. 5A-5E are diagrams of non-limiting embodiments or aspects of an implementation of a process for generating a machine learning model and/or a prediction based on encoded time series data using model reduction techniques.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments of the disclosure. Hence, specific dimensions and other physical characteristics related to the embodiments of the embodiments disclosed herein are not to be considered as limiting unless otherwise indicated.

No aspect, component, element, structure, act, step, function, instruction, and/or the like used herein should be construed as critical or essential unless explicitly described as such. In addition, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. The phase “based on” may also mean “in response to” where appropriate.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments or aspects, a message may refer to a network packet (e.g., a data packet and/or the like) that includes data.

As used herein, the terms “issuer,” “issuer institution,” “issuer bank,” or “payment device issuer,” may refer to one or more entities that provide accounts to individuals (e.g., users, customers, and/or the like) for conducting payment transactions, such as credit payment transactions and/or debit payment transactions. For example, an issuer institution may provide an account identifier, such as a primary account number (PAN), to a customer that uniquely identifies one or more accounts associated with that customer. In some non-limiting embodiments or aspects, an issuer may be associated with a bank identification number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network, such as Visa®, MasterCard®, American Express®, or any other entity that processes transactions. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments or aspects, may be operated by or on behalf of a transaction service provider.

As used herein, the term “merchant” may refer to one or more entities (e.g., operators of retail businesses) that provide goods and/or services, and/or access to goods and/or services, to a user (e.g., a customer, a consumer, and/or the like) based on a transaction, such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “acquirer” may refer to an entity licensed by the transaction service provider and approved by the transaction service provider to originate transactions (e.g., payment transactions) involving a payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments or aspects, the acquirer may be authorized by the transaction service provider to assign merchant or service providers to originate transactions involving a payment device associated with the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by the acquirer's payment facilitators, and/or the like. In some non-limiting embodiments or aspects, an acquirer may be a financial institution, such as a bank.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway.

As used herein, the terms “client” and “client device” may refer to one or more computing devices, such as processors, storage devices, and/or similar computer components, that access a service made available by a server. In some non-limiting embodiments or aspects, a client device may include a computing device configured to communicate with one or more networks and/or facilitate transactions such as, but not limited to, one or more desktop computers, one or more portable computers (e.g., tablet computers), one or more mobile devices (e.g., cellular phones, smartphones, personal digital assistant, wearable devices, such as watches, glasses, lenses, and/or clothing, and/or the like), and/or other like devices. Moreover, the term “client” may also refer to an entity that owns, utilizes, and/or operates a client device for facilitating transactions with another entity.

As used herein, the term “server” may refer to one or more computing devices, such as processors, storage devices, and/or similar computer components that communicate with client devices and/or other computing devices over a network, such as the Internet or private networks and, in some examples, facilitate communication among other servers and/or client devices.

As used herein, the term “system” may refer to one or more computing devices or combinations of computing devices such as, but not limited to, processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Provided are systems, methods, and computer program products for generating a machine learning model and/or a prediction based on encoded time series data using model reduction techniques. Embodiments of the present disclosure may include a model reduction system for time series forecasting with machine learning models to reduce (e.g., eliminate, decrease, and/or the like) training time, increase model prediction accuracy, and increase model robustness to noise and missing data values. In some non-limiting embodiments or aspects, the model reduction system may receive a training dataset of a plurality of data instances, where each data instance comprises a time series of data points. In some non-limiting embodiments or aspects, the model reduction system may perform an encoding operation on the training dataset to provide an encoded dataset having a lower dimension space than a dimension space of the training dataset. In some non-limiting embodiments or aspects, the model reduction system may generate one or more prediction models based on the encoded dataset, where the one or more prediction models are configured to provide an output in the lower dimension space. In some non-limiting embodiments or aspects, the model reduction system may determine an output of the one or more prediction models in the lower dimension space based on an input provided to the one or more prediction models. In some non-limiting embodiments or aspects, the model reduction system may perform a decoding operation on the output to project the output from the lower dimension space to the dimension space of the training dataset.

In some non-limiting embodiments or aspects, when generating the one or more prediction models, the model reduction system may train the one or more prediction models in the lower dimension space based on the encoded dataset. In some non-limiting embodiments or aspects, when performing the encoding operation on the dataset to provide the encoded dataset, the model reduction system may perform a factorization operation based on an optimization problem, wherein the optimization problem is the following:

$${min}_{F , X , W} {\sum }_{( i , t ) ∈ Ω} {( {Y}_{it} - {f}_{i}^{T} {x}_{t} )}^{2} + {λ}_{f} {ℛ}_{f} ( F ) + {\sum }_{r = 1}^{k} {λ}_{x} {𝒯}_{AR} ( {\overline{x}}_{r} \vert ℒ , {\overline{𝓌}}_{r} , η ) + {λ}_{w} {ℛ}_{w} ( 𝒲 ) ,$$

$$wherein :$$

$${𝒯}_{AR} ( \overline{x} \vert ℒ , \overline{ω} , η ) = \frac{1}{2} {\sum }_{t = m}^{T} {( {x}_{t} - {\sum }_{l ∈ ℒ} {ω}_{l} {x}_{t - l} )}^{2} + \frac{η}{2} {‖ \overline{x} ‖}^{2} ,$$

and

wherein:

xₜ= [symbol] W^{(l)}xₜ₋ₗ+ϵₜ
wherein Yᵢₜ is the training dataset, i is an i-th observation target, t is a time stamp of each data point of the time series of data points, F is a projection matrix, fᵢ^{T} is a translation to an i-th row of the projection matrix F, X is the encoded dataset having a lower dimension space, xₜ is a data point of the time series of data points, k is a first dimension of the encoded dataset X, [symbol] _{f}(F) is a squared Frobenius norm of the projection matrix F, λ_{f} is a weight of the projection matrix F, W is an auto-regression model, [symbol] _{w}(W) is a squared Frobenius norm of the auto-regression model W, λ_{W} is a weight of the auto-regression model W, [symbol] is a score of the auto-regression model W, λₓ is a weight of the score of the auto-regression model [symbol] , [symbol] is a second dimension of the encoded dataset X, w is a prediction model, η is a weight to a vector norm, l is an individual component of the second dimension [symbol] , T is a total time of the of the time series of data points, and Et is an error value associated with xₜ.

In some non-limiting embodiments or aspects, when performing the factorization operation, the model reduction system may update the projection matrix F using a least square optimization problem, update the transferred low-dimensional space X using a graph-regularized alternating least squares (GRALS), and update the auto-regression model W by solving the following:

$$arg {min}_{\overline{ω}} {λ}_{x} {𝒯}_{AR} ( {\overline{x}}_{r} \vert ℒ , \overline{ω} , η ) + {λ}_{w} {‖ \overline{ω} ‖}^{2} = arg {min}_{\overline{ω}} {\sum }_{t = m}^{T} {( {x}_{t} - {\sum }_{l ∈ ℒ} {ω}_{l} {x}_{t - l} )}^{2} + \frac{{λ}_{w}}{{λ}_{x}} {‖ \overline{ω} ‖}^{2} .$$

In some non-limiting embodiments or aspects, when performing the decoding operation on the output to project the output from the lower dimension space to the dimension space of the training dataset, the model reduction system may project the output from the lower dimension space to the dimension space of the training dataset using an inverse of the projection matrix F.

In some non-limiting embodiments or aspects, the lower dimension space has a first dimension and a second dimension, and the dimension space of the training dataset has a first dimension and a second dimension, the first dimension of the lower dimension space is less than the first dimension of the training dataset, and the second dimension of the lower dimension space is equal to the second dimension of the training dataset. In some non-limiting embodiments or aspects, the one or more prediction models may include a number of prediction models, and the number of prediction models may be equal to the first dimension of the lower dimension space.

In this way, the model reduction system may generate a machine learning model with increased accuracy and reduced training time by generating a prediction model through training a machine learning model using encoded training datasets at a reduced dimension and generating a prediction in the encoded space that may be decoded into a final prediction. The model reduction system may use a training dataset with reduced dimensionality compared to the original training dataset to build robust and accurate deep learning models. In some non-limiting embodiments or aspects, the model reduction system may encode the training dataset to provide the training dataset in a lower dimension space to train the machine learning model to have an increased robustness to noise and missing data when generating a prediction. In some non-limiting embodiments or aspects, the model reduction system may project the training dataset in the lower dimension and train the machine learning model, resulting in a lower number of models needing to be trained, reducing the overall training time to generate machine learning models which are capable of generating accurate predictions given large datasets as input.

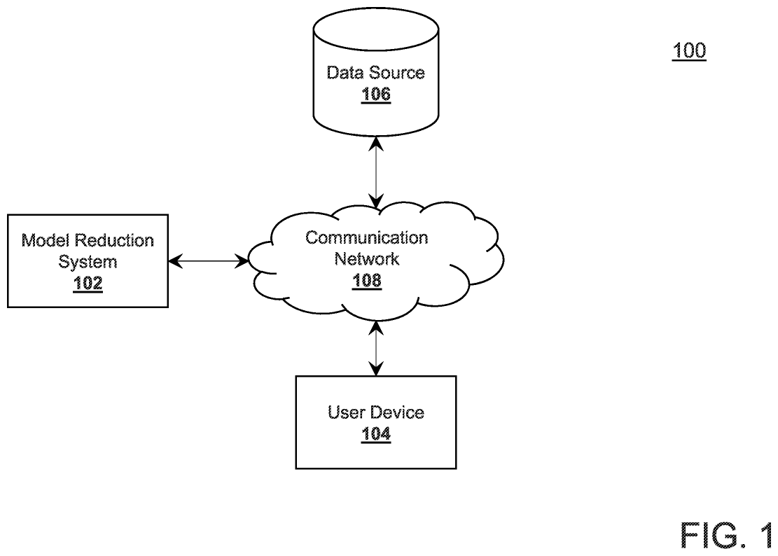

Referring now to FIG. 1, FIG. 1 is a diagram of an example environment 100 in which devices, systems, methods, and/or products described herein may be implemented. As shown in FIG. 1, environment 100 includes model reduction system 102, user device 104, data source 106, and communication network 108. Model reduction system 102, user device 104, and data source 106 may interconnect (e.g., establish a connection to communicate, and/or the like) via wired connections, wireless connections, or a combination of wired and wireless connections.

Model reduction system 102 may include one or more computing devices configured to communicate with user device 104, and/or data source 106 via communication network 108. For example, model reduction system 102 may include a group of servers and/or other like devices. In some non-limiting embodiments or aspects, model reduction system 102 may be associated with (e.g., operated by) a transaction service provider, as described herein. Additionally or alternatively, model reduction system 102 may be a component of a transaction service provider system, an issuer system, and/or a merchant system. In some non-limiting embodiments or aspects, model reduction system 102 may include one or more machine learning models. The machine learning models may be trained using unsupervised and/or supervised methods. In some non-limiting embodiments or aspects, the machine learning models may be trained using datasets received from data source 106. Additionally or alternatively, the machine learning models may provide a prediction output based on testing and/or production datasets received from data source 106. In some non-limiting embodiments or aspects, output from one machine learning model may be used as input for training other machine learning models that are part of model reduction system 102.

User device 104 may include one or more computing devices configured to communicate with model reduction system 102 and/or data source 106 via communication network 108. For example, user device 104 may include a desktop computer (e.g., a client device that communicates with a server), a mobile device, and/or the like. In some non-limiting embodiments or aspects, user device 104 may be associated with a user (e.g., an individual operating a device).

Data source 106 may include one or more datasets used for training one or more machine learning models. In some non-limiting embodiments or aspects, data source 106 may include one or more static training datasets and/or one or more real-time training datasets. For example, data source 106 may include real-time training datasets which may be constantly updated with new data. In some non-limiting embodiments or aspects, data source 106 may include static training datasets which have been previously compiled and stored in data source 106. In this way, static training datasets may not receive new data. Data source 106 may be updated with new data via communication network 108. Data source 106 may be configured to communicate with model reduction system 102 and/or user device 104 via communication network 108. In some non-limiting embodiments or aspects, data source 106 may be updated with new data from one or more machine learning models. For example, output from one or more machine learning models may be communicated to data source 106 for storage. In some non-limiting embodiments or aspects, output from one or more machine learning models stored in data source 106 may be used as input to one or more other machine learning models for future training.

In some non-limiting embodiments or aspects, a dataset may include a training dataset. In some non-limiting embodiments or aspects, a dataset may include a testing dataset. In some non-limiting embodiments or aspects, a dataset may include a production dataset. In some non-limiting embodiments or aspects, a machine learning model may receive a training dataset to train the machine learning model. Additionally or alternatively, a machine learning model may receive a testing dataset to evaluate the performance of the machine learning model. In some non-limiting embodiments or aspects, a machine learning model may receive a production dataset to provide a prediction output.

Communication network 108 may include one or more wired and/or wireless networks. For example, communication network 108 may include a cellular network (e.g., a long-term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of some or all of these or other types of networks.

The number and arrangement of systems and/or devices shown in FIG. 1 is provided as an example. There may be additional systems and/or devices, fewer systems and/or devices, different systems and/or devices, or differently arranged systems and/or devices than those shown in FIG. 1. Furthermore, two or more systems and/or devices shown in FIG. 1 may be implemented within a single system or a single device, or a single system or a single device shown in FIG. 1 may be implemented as multiple, distributed systems or devices. Additionally or alternatively, a set of systems or a set of devices (e.g., one or more systems, one or more devices) of environment 100 may perform one or more functions described as being performed by another set of systems or another set of devices of environment 100.

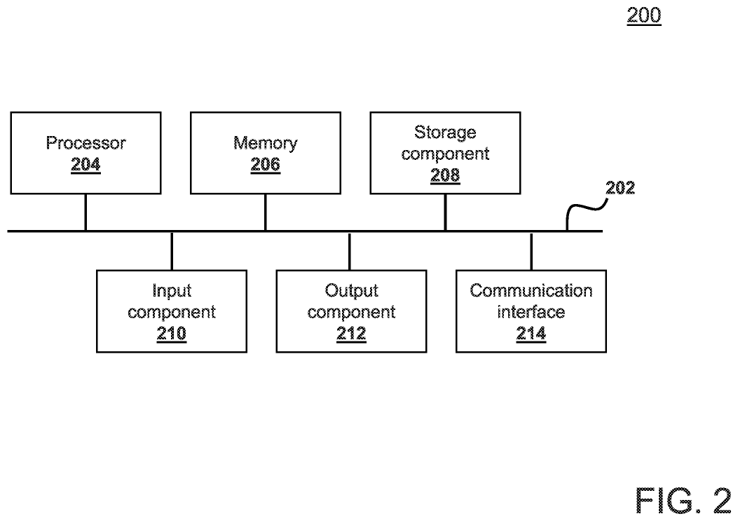

Referring now to FIG. 2, FIG. 2 is a diagram of example components of device 200. Device 200 may correspond to model reduction system 102 (e.g., one or more devices of model reduction system 102), user device 104, and/or data source 106. In some non-limiting embodiments or aspects, model reduction system 102, user device 104, and/or data source 106 may include at least one device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive. In some non-limiting embodiments or aspects, storage component 208 may be the same as or similar to data source 106.

Input component 210 may include a component that permits device 200 to receive information, such as via user input (e.g., a touchscreen display, a keyboard, a keypad, a mouse, a button, a switch, a microphone, a camera, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a Bluetooth® interface, a Zigbee® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments described herein are not limited to any specific combination of hardware circuitry and software.

Memory 206 and/or storage component 208 may include data storage or one or more data structures (e.g., a database and/or the like). Device 200 may be capable of receiving information from, storing information in, communicating information to, or searching information stored in the data storage or one or more data structures in memory 206 and/or storage component 208. For example, the information may include input data, output data, transaction data, account data, or any combination thereof.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

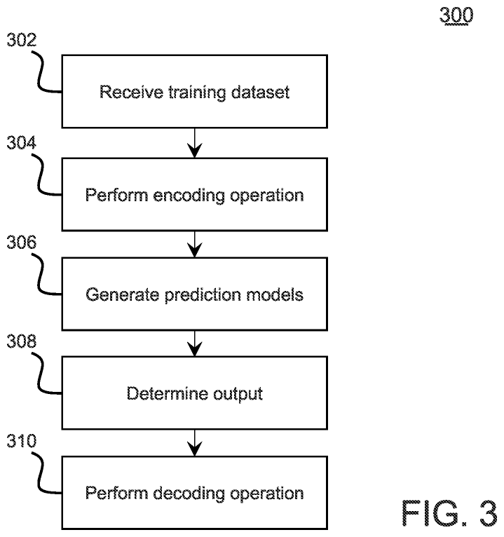

Referring now to FIG. 3, FIG. 3 is a flowchart of a non-limiting embodiment or aspect of a process 300 for generating a machine learning model based on encoded time series data using model reduction techniques. In some non-limiting embodiments or aspects, one or more of the functions described with respect to process 300 may be performed (e.g., completely, partially, etc.) by model reduction system 102. In some non-limiting embodiments or aspects, one or more of the steps of process 300 may be performed (e.g., completely, partially, and/or the like) by another device or a group of devices separate from or including model reduction system 102, such as user device 104. In some non-limiting embodiments or aspects, one or more of the steps of process 300 may be performed during a training phase. In some non-limiting embodiments or aspects, the training phase may include an environment where a machine learning model, such as a prediction model, is being trained (e.g., training environment, model building phase, and/or the like). In some non-limiting embodiments or aspects, one or more of the steps of process 300 may be performed during a testing phase. In some non-limiting embodiments or aspects, the testing phase may include an environment where a machine learning model, such as a prediction model, is being tested (e.g., testing environment, model evaluation, model validation, and/or the like).

As shown in FIG. 3, at step 302, process 300 may include receiving a training dataset. In some non-limiting embodiments or aspects, model reduction system 102 may receive a training dataset during the training phase. In some non-limiting embodiments or aspects, model reduction system 102 may receive a training dataset during the testing phase. In some non-limiting embodiments or aspects, model reduction system 102 may receive a training dataset of a plurality of data instances, wherein each data instance comprises a time series of data points. For example, model reduction system 102 may receive a training dataset from data source 106 for training one or more machine learning models. In some non-limiting embodiments or aspects, model reduction system 102 may receive a testing dataset from data source 106 for evaluating (e.g., validating) one or more machine learning models. In some non-limiting embodiments or aspects, model reduction system 102 may provide the training dataset as the input to one or more machine learning models based on receiving the training dataset.

In some non-limiting embodiments or aspects, model reduction system 102 may receive a training dataset in real-time as a time sequenced dataset as the data is being collected. In some non-limiting embodiments or aspects, model reduction system 102 may receive a training dataset corresponding to output from one or more machine learning models. For example, model reduction system 102 may receive a training dataset corresponding to an output of a trained machine learning model, where the output may be provided as an input to the one or more machine learning models. In some non-limiting embodiments or aspects, model reduction system 102 may receive a testing dataset in real-time as a time sequenced dataset as the data is being collected. In some non-limiting embodiments or aspects, model reduction system 102 may receive a testing dataset corresponding to output from one or more machine learning models.

In some non-limiting embodiments or aspects, each data instance of the plurality of data instances of the training dataset may represent an institution (e.g., issuer, bank, merchant, and/or the like). In some non-limiting embodiments or aspects, each data instance of the plurality of data instances may be associated with a plurality of events (e.g., transactions, account openings, fund transfers, etc.). In some non-limiting embodiments or aspects, each data point (e.g., data vector) of the plurality of data instances may represent an event, such as an electronic payment transaction (e.g., an electronic credit card payment transaction, an electronic debit card payment transaction, etc.) between a user associated with user device 104 and a merchant associated with a merchant system. For example, a data instance may include a plurality of data points (e.g., data vectors) at each time stamp where each data point includes data associated with the electronic payment transaction, such as a transaction amount, PAN, merchant type, and/or the like. In some non-limiting embodiments or aspects, each data point may be received in real-time with respect to the event.

In some non-limiting embodiments or aspects, each data instance may be stored and compiled into a training dataset for future training. In some non-limiting embodiments or aspects, each data instance may include transaction data associated with the electronic payment transaction. In some non-limiting embodiments or aspects, transaction data may include transaction parameters associated with an electronic payment transaction. Transaction parameters may include electronic wallet card data associated with an electronic card (e.g., an electronic credit card, an electronic debit card, an electronic loyalty card, and/or the like), decision data associated with a decision (e.g., a decision to approve or deny a transaction authorization request), authorization data associated with an authorization response (e.g., an approved spending limit, an approved transaction value, and/or the like), a PAN, an authorization code (e.g., a PIN, etc.), data associated with a transaction amount (e.g., an approved limit, a transaction value, etc.), data associated with a transaction date and time, data associated with a conversion rate of a currency, data associated with a merchant type (e.g., goods, grocery, fuel, and/or the like), data associated with an acquiring institution country, data associated with an identifier of a country associated with the PAN, data associated with a response code, data associated with a merchant identifier (e.g., a merchant name, a merchant location, and/or the like), data associated with a type of currency corresponding to funds stored in association with the PAN, and/or the like.

In some non-limiting embodiments or aspects, model reduction system 102 may generate one or more trained machine learning models, such as a prediction model. For example, model reduction system 102 may generate a prediction model to provide a predicted classification of a data instance, such as a data instance including a time series of data points where each data point represents an event, based on the training dataset.

In some non-limiting embodiments or aspects, model reduction system 102 may process data instances associated with events (e.g., historical data instances associated with events) to obtain training data (e.g., one or more training datasets) for the machine learning model. For example, model reduction system 102 may process the data to change the data into a format that may be analyzed (e.g., by model reduction system 102) to generate one or more trained machine learning models, such as a prediction model. Additionally or alternatively, model reduction system 102 may process the data to obtain the training data based on model reduction system 102 receiving an indication, from a user (e.g., a user associated with user device 104) of model reduction system 102, that model reduction system 102 is to process the data, such as when model reduction system 102 receives an indication to generate a machine learning model for predicting a classification of an event.

In some non-limiting embodiments or aspects, model reduction system 102 may process the plurality of data instances associated with events by determining a prediction variable based on the data. A prediction variable may include a metric, associated with events, which may be derived based on the plurality of data instances associated with events. The prediction variable may be analyzed to generate a trained machine learning model, such as a prediction model. For example, the prediction variable may include a variable associated with a time of an event, a variable associated with a parameter of an event, a variable associated with a number of occurrences of an aspect of an event, and/or the like.

In some non-limiting embodiments or aspects, model reduction system 102 may analyze the training datasets to generate one or more trained machine learning models. For example, model reduction system 102 may use machine learning techniques to analyze the training datasets to generate a trained machine learning model. In some non-limiting embodiments or aspects, generating a trained machine learning model (e.g., based on training data) may be referred to as training a machine learning model. The machine learning techniques may include, for example, supervised and/or unsupervised techniques, such as decision trees, random forests, logistic regressions, linear regression, gradient boosting, support-vector machines, extra-trees (e.g., an extension of random forests), Bayesian statistics, learning automata, Hidden Markov Modeling, linear classifiers, quadratic classifiers, association rule learning, and/or the like. In some non-limiting embodiments or aspects, the machine learning model may include a model that is specific to a particular characteristic, for example, a model that is specific to a particular entity (e.g., an issuer) involved in an event, a particular time interval during which an event occurred, and/or the like. Additionally or alternatively, the machine learning model may be specific to particular entities (e.g., business entities, such as merchants, consumer entities, such as account holders of accounts issued by issuers, issuers, etc.) that are involved in the events. In some non-limiting embodiments or aspects, model reduction system 102 may generate one or more trained machine learning models for one or more entities, a particular group of entities, and/or one or more users of one or more entities.

Additionally or alternatively, when analyzing the training data, model reduction system 102 may identify one or more variables (e.g., one or more independent variables) as predictor variables (e.g., features) that may be used to make a prediction. In some non-limiting embodiments or aspects, values of the predictor variables may be inputs to a machine learning model, such as a prediction model. For example, model reduction system 102 may identify a subset (e.g., a proper subset) of the variables as the predictor variables that may be used to accurately predict a classification of an event. In some non-limiting embodiments or aspects, the predictor variables may include one or more of the prediction variables, as discussed above, that have a significant impact (e.g., an impact satisfying a threshold) on a predicted classification of an event as determined by model reduction system 102.

In some non-limiting embodiments or aspects, model reduction system 102 may validate a machine learning model. For example, model reduction system 102 may validate the machine learning model after model reduction system 102 generates the machine learning model. In some non-limiting embodiments or aspects, model reduction system 102 may validate the machine learning model based on a portion of the training datasets to be used for validation. For example, model reduction system 102 may partition the training datasets into a first portion and a second portion, where the first portion may be used to generate a machine learning model, as described above. In some non-limiting embodiments or aspects, model reduction system 102 may validate the machine learning model based on a testing dataset. In some non-limiting embodiments or aspects, model reduction system 102 may validate the machine learning model during the testing phase.

In some non-limiting embodiments or aspects, model reduction system 102 may validate the machine learning model by providing validation data associated with a user (e.g., data associated with one or more events involving a user) as input to the machine learning model, and determining, based on an output of the machine learning model, whether the machine learning model correctly, or incorrectly, predicted a classification of an event. In some non-limiting embodiments or aspects, model reduction system 102 may validate the machine learning model based on a validation threshold. For example, model reduction system 102 may be configured to validate the machine learning model when the classifications of a plurality of events (as identified by the validation data) are correctly predicted by the machine learning model (e.g., when the machine learning model correctly predicts 50% of the classifications of a plurality of events, 70% of the classifications of a plurality of events, a threshold quantity of the classifications of a plurality of events, and/or the like).

In some non-limiting embodiments or aspects, if model reduction system 102 does not validate the machine learning model (e.g., when a percentage of correctly predicted classifications of a plurality of events does not satisfy the validation threshold), then model reduction system 102 may generate one or more additional machine learning models.

In some non-limiting embodiments or aspects, once the machine learning model has been validated, model reduction system 102 may further train the machine learning model and/or generate new machine learning models based on receiving new training datasets. The new training datasets may include additional data associated with one or more events. In some non-limiting embodiments or aspects, the new training datasets may include data associated with an additional plurality of events. Model reduction system 102 may use the machine learning model to predict the classifications of the additional plurality of events and compare an output of a machine learning model to the new training datasets. For example, model reduction system 102 may update one or more trained machine learning models based on the new training data.

In some non-limiting embodiments or aspects, model reduction system 102 may store the trained machine learning model. For example, model reduction system 102 may store the trained machine learning model in a data structure (e.g., a database, a linked list, a tree, and/or the like). The data structure may be located within model reduction system 102 or external (e.g., remote from) model reduction system 102.

As shown in FIG. 3, at step 304, process 300 may include performing an encoding operation. In some non-limiting embodiments or aspects, model reduction system 102 may perform an encoding operation on the training dataset to provide an encoded dataset having a lower dimension space than a dimension space of the training dataset. In some non-limiting embodiments or aspects, model reduction system 102 may perform an encoding operation on the training dataset based on a projection matrix. In some non-limiting embodiments or aspects, model reduction system 102 may perform an encoding operation on the training dataset based on an optimization cost problem. For example, model reduction system 102 may perform an encoding operation on the training dataset based on the following optimization problem:

$${min}_{F , X , W} {\sum }_{( i , t ) ∈ Ω} {( {Y}_{it} - {f}_{i}^{T} {x}_{t} )}^{2} + {λ}_{f} {ℛ}_{f} ( F ) + {\sum }_{r = 1}^{k} {λ}_{x} {𝒯}_{AR} ( {\overline{x}}_{r} \vert ℒ , {\overline{𝓌}}_{r} , η ) + {λ}_{w} {ℛ}_{w} ( 𝒲 ) ,$$

where Yᵢₜ is the training dataset, i is the i-th observation target (e.g., business entities, such as merchants, consumer entities, such as account holders of accounts issued by issuers, issuers, etc.), t is the time stamp of each data point of the time series of data points, F is the projection matrix, fᵢ^{T} is a translation to the i-th row of the projection matrix F, X is the encoded dataset having a lower dimension space for training, xₜ is a column of X at time stamp t (e.g., a data point of the time series of data points at time t), k is a first dimension of X, where k is less than a first dimension of the training dataset, [symbol] _{f}(F) is the squared Frobenius norm to projection matrix F, λ_{f} is the weight of projection matrix F, W is an auto-regression model, [symbol] _{w}(W) is the squared Frobenius norm to the auto-regression model W, λ_{w} is the weight of the auto-regression model W, [symbol] is the score of the auto-regression model W, λₓ is the weight of the score of the auto-regression model [symbol] , [symbol] represents a set of recorded time stamps used for the prediction (e.g., a second dimension of the encoded dataset X, where the second dimension may represent a number of time series data points in a data instance), w is the prediction model, and η is the weight to vector norm.

In some non-limiting embodiments or aspects, when performing the encoding operation on the dataset, model reduction system 102 may perform a factorization operation based on the optimization problem. In some non-limiting embodiments or aspects, the score of the auto-regression model term, [symbol] , may be represented by the following equation:

$${𝒯}_{AR} ( \overline{x} \vert ℒ , \overline{ω} , η ) = \frac{1}{2} {\sum }_{t = m}^{T} {( {x}_{t} - {\sum }_{l ∈ ℒ} {ω}_{l} {x}_{t - l} )}^{2} + \frac{η}{2} {‖ \overline{x} ‖}^{2}$$

where l is an individual component (e.g., an indexed time stamp) of length [symbol] of the set of recorded time stamps used for the prediction, and T is the total time (e.g., duration) of the time series of data points in the data instance.

In some non-limiting embodiments or aspects, a column of X at time stamp t, xₜ, may be represented by the following equation:

xₜ= [symbol] W^{(l)}xₜ₋ₗ+ϵₜ

where ϵₜ is a hyperparameter for the projection matrix F associated with xₜ (e.g., a hyperparameter associated with adjusting for a missing value, noise, etc.).

In some non-limiting embodiments or aspects, when performing the factorization operation, model reduction system 102 may update the projection matrix using a least square optimization problem. In some non-limiting embodiments or aspects, when performing the factorization operation, model reduction system 102 may update the transferred low-dimensional space X using a graph-regularized alternating least squares (GRALS). In some non-limiting embodiments or aspects, when performing the factorization operation, model reduction system 102 may update the auto-regression model W by solving the following:

$$arg {min}_{\overline{ω}} {λ}_{x} {𝒯}_{AR} ( {\overline{x}}_{r} \vert ℒ , \overline{ω} , η ) + {λ}_{w} {‖ \overline{ω} ‖}^{2} = arg {min}_{\overline{ω}} {\sum }_{t = m}^{T} {( {x}_{t} - {\sum }_{l ∈ ℒ} {ω}_{l} {x}_{t - l} )}^{2} + \frac{{λ}_{w}}{{λ}_{x}} {‖ \overline{ω} ‖}^{2}$$

As shown in FIG. 3, at step 306, process 300 may include generating prediction models. In some non-limiting embodiments or aspects, model reduction system 102 may generate one or more prediction models based on the encoded dataset. In some non-limiting embodiments or aspects, the one or more prediction models may be configured to provide an output in the lower dimension space. In some non-limiting embodiments or aspects, the output of the one or more prediction models may include a predicted classification value for an event, such as a real-time event, that is provided as an input. In some non-limiting embodiments or aspects, a real-time event may refer to an event that is detected and/or received by model reduction system 102 instantaneously, or in a guaranteed time within a specified deadline (e.g., within a matter of milliseconds, not greater than a few seconds, etc.) with respect to the occurrence of the actual event. In some non-limiting embodiments or aspects, the output of the one or more prediction models may include a predicted classification value for an event where the output includes a time series forecast of a plurality of events.

In some non-limiting embodiments or aspects, when generating the one or more prediction models based on the encoded dataset, model reduction system 102 may train the one or more prediction models in the lower dimension space based on the encoded dataset.

As shown in FIG. 3, at step 308, process 300 may include determining an output. In some non-limiting embodiments or aspects, model reduction system 102 may determine an output of the one or more prediction models in the lower dimension space based on an input provided to the one or more prediction models. For example, model reduction system 102 may determine an output of the one or more prediction models including a time series forecast in the lower dimension space. In some non-limiting embodiments or aspects, the time series forecast may include a specified time range (e.g., week, month, year, etc.). In some non-limiting embodiments or aspects, the output may include the classification of one or more events of a time series.

As shown in FIG. 3, at step 310, process 300 may include performing a decoding operation. In some non-limiting embodiments or aspects, model reduction system 102 may perform a decoding operation on the output to project the output from the lower dimension space to the dimension space of the training dataset. For example, model reduction system 102 may perform a decoding operation on the output based on an inverse matrix corresponding to the projection matrix. In some non-limiting embodiments or aspects, when performing the decoding operation on the output to project the output from the lower dimension space to the dimension space of the training dataset, model reduction system 102 may project the output from the lower dimension space to the dimension space of the training dataset using an inverse of the projection matrix F.

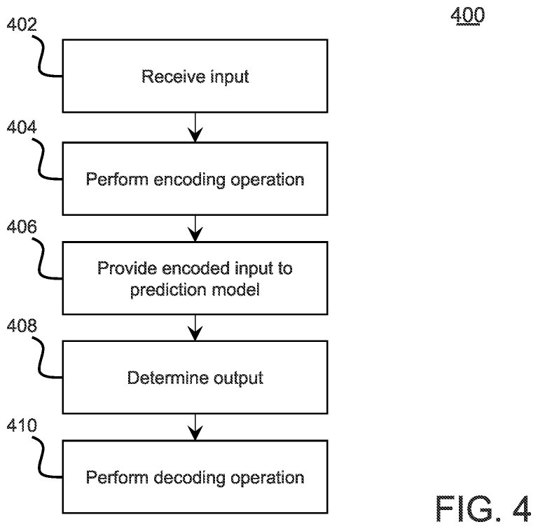

Referring now to FIG. 4, FIG. 4 is a flowchart of a non-limiting embodiment or aspect of a process 400 for generating a prediction based on encoded time series data using model reduction techniques. In some non-limiting embodiments or aspects, one or more of the functions described with respect to process 400 may be performed (e.g., completely, partially, etc.) by model reduction system 102. In some non-limiting embodiments or aspects, one or more of the steps of process 400 may be performed (e.g., completely, partially, and/or the like) by another device or a group of devices separate from or including model reduction system 102, such as user device 104. In some non-limiting embodiments or aspects, one or more of the steps of process 400 may be performed at runtime. In some non-limiting embodiments or aspects, runtime may include an environment where a machine learning model, such as a prediction model, is being executed (e.g., production environment, monitoring phase after deployment of model, and/or the like).

As shown in FIG. 4, at step 402, process 400 may include receiving an input. In some non-limiting embodiments or aspects, model reduction system 102 may receive a time series dataset of a plurality of data instances as input. In some non-limiting embodiments or aspects, model reduction system 102 may receive an input for testing (e.g., evaluation, validation, etc.). In some non-limiting embodiments or aspects, model reduction system 102 may receive an input at runtime. In some non-limiting embodiments or aspects, model reduction system 102 may receive an input that is generated in real-time. For example, model reduction system 102 may receive real-time transaction data (e.g., authorization data, transaction amount, issuer identity, and/or the like) over time as the transaction data is being collected. In some non-limiting embodiments or aspects, model reduction system 102 may receive previously collected and/or stored (e.g., historical) transaction data as an input from data source 106.

In some non-limiting embodiments or aspects, the input may include output from one or more machine learning models, such as one or more prediction models. In some non-limiting embodiments or aspects, the input may include a complete dataset or an incomplete dataset. In some non-limiting embodiments or aspects, an incomplete dataset may include a dataset that is missing one or more data points of a time series. In other non-limiting embodiments or aspects, the input may include data from a plurality of different datasets. In some non-limiting embodiments or aspects, model reduction system 102 may receive a plurality of data instances associated with the training dataset, and model reduction system 102 may provide the plurality of data instances associated with the training dataset as input to one or more trained machine learning models. In some non-limiting embodiments or aspects, model reduction system 102 may generate an output from one or more trained machine learning models based on the plurality of data instances as input.

In some non-limiting embodiments or aspects, model reduction system 102 may generate a plurality of predicted classification values based on receiving the training dataset. The plurality of predicted classification values may include a predicted classification value for each classification (e.g., each class label) for which the trained machine learning model is configured to provide a prediction. In some non-limiting embodiments or aspects, the predicted classification values may include an amount of time associated with the event. For example, the predicted classification values may represent an amount of time taken to complete the event. In one example, the predicted classification values may represent an amount of time (e.g., a number of days) taken to clear (e.g., a process that involves activities that turn the promise of payment, such as in the form of an electronic payment request, into an actual movement of electronic funds from one account to another) an electronic payment transaction between a user associated with user device 104 and a merchant associated with a merchant system.

In some non-limiting embodiments or aspects, model reduction system 102 may determine a classification (e.g., a predicted classification, an initial predicted classification, and/or the like) of each data instance of the dataset. For example, model reduction system 102 may determine the classification of the initial input by providing the initial input to one or more trained machine learning models (e.g., a trained machine learning model that includes a random forest, a multilayer perceptron, and/or a neural network, such as a deep neural network) and determine the classification as an output from the machine learning models. In some non-limiting embodiments or aspects, one or more of the trained machine learning models may be a machine learning classifier that includes a deep learning network. In some non-limiting embodiments or aspects, the classification may be associated with a class that includes a group of members, and the classification may refer to a characteristic that is shared among the members of the group in the class. In some non-limiting embodiments or aspects, model reduction system 102 may store the training dataset in a database.

As shown in FIG. 4, at step 404, process 400 may include performing an encoding operation. In some non-limiting embodiments or aspects, model reduction system 102 may perform an encoding operation at runtime. In some non-limiting embodiments or aspects, model reduction system 102 may perform an encoding operation on the input to provide an encoded input in a same or similar fashion as described in step 304. In some non-limiting embodiments or aspects, model reduction system 102 may perform an encoding operation on the input to provide an encoded input having a lower dimension space than a dimension space of the input. In some non-limiting embodiments or aspects, model reduction system 102 may perform an encoding operation on the input based on a projection matrix. In some non-limiting embodiments or aspects, model reduction system 102 may perform an encoding operation on input based on the optimization cost problem as provided herein.

In some non-limiting embodiments or aspects, when performing the encoding operation on the input, model reduction system 102 may perform a factorization operation based on the optimization problem as provided herein. In some non-limiting embodiments or aspects, when performing the factorization operation, model reduction system 102 may update the projection matrix using a least square optimization problem. In some non-limiting embodiments or aspects, when performing the factorization operation, model reduction system 102 may update the transferred low-dimensional space and/or the auto-regression model as provided herein.

As shown in FIG. 4, at step 406, process 400 may include providing encoded input to a prediction model. In some non-limiting embodiments or aspects, model reduction system 102 may provide encoded input to a prediction model at runtime. In some non-limiting embodiments or aspects, the prediction model may be based on an autoregressive model. In some non-limiting embodiments or aspects, the prediction model may include an autoregressive integrated moving average (ARIMA) model. In some non-limiting embodiments or aspects, the prediction model may include a decomposable, additive time series model (e.g., Facebook® Prophet).

As shown in FIG. 4, at step 408, process 400 may include determining an output. In some non-limiting embodiments or aspects, model reduction system 102 may determine an output at runtime. In some non-limiting embodiments or aspects, model reduction system 102 may determine an output of the prediction model in the lower dimension space based on the encoded input provided to the prediction model. For example, model reduction system 102 may determine an output of the prediction model including a time series forecast in the lower dimension space. In some non-limiting embodiments or aspects, the time series forecast may include a specified time range (e.g., week, month, year, etc.). In some non-limiting embodiments or aspects, the output may include the classification of one or more events of a time series.

As shown in FIG. 4, at step 410, process 400 may include performing a decoding operation. In some non-limiting embodiments or aspects, model reduction system 102 may perform a decoding operation at runtime. In some non-limiting embodiments or aspects, model reduction system 102 may perform a decoding operation on the output to project the output from the lower dimension space to the dimension space of the input. In some non-limiting embodiments or aspects, when performing the decoding operation on the output to project the output from the lower dimension space to the dimension space of the training dataset, model reduction system 102 may project the output from the lower dimension space to the dimension space of the training dataset using an inverse of the projection matrix F.

In some non-limiting embodiments or aspects, model reduction system 102 may perform an action based on the output. For example, model reduction system 102 may reject a transaction based on the output indicating that the transaction possesses a high risk (e.g., surpasses a risk threshold). As a further example, model reduction system 102 may post a transaction based on an output prediction that the transaction is likely to settle (e.g., surpasses a likelihood threshold). In some non-limiting embodiments or aspects, model reduction system 102 may perform a time-based action based on the output. For example, model reduction system 102 may preauthorize transactions for a specific PAN for a certain amount of time based on a time series output prediction (e.g., time series forecast). In some non-limiting embodiments or aspects, model reduction system 102 may perform an action based on the output during runtime.

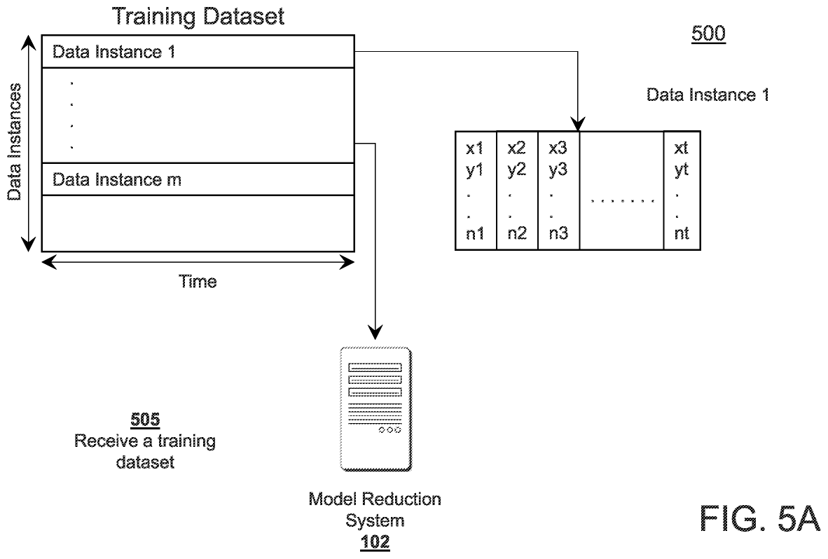

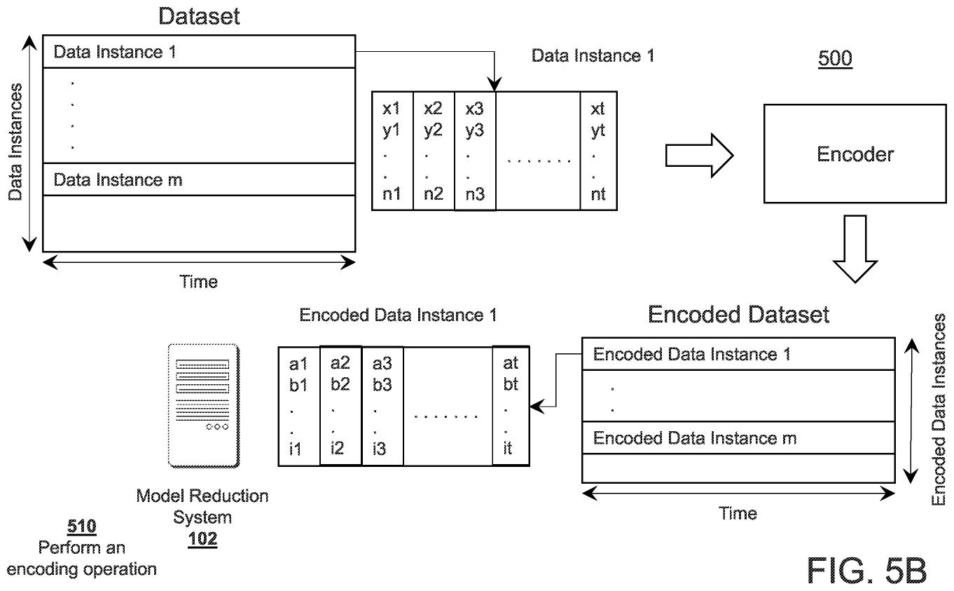

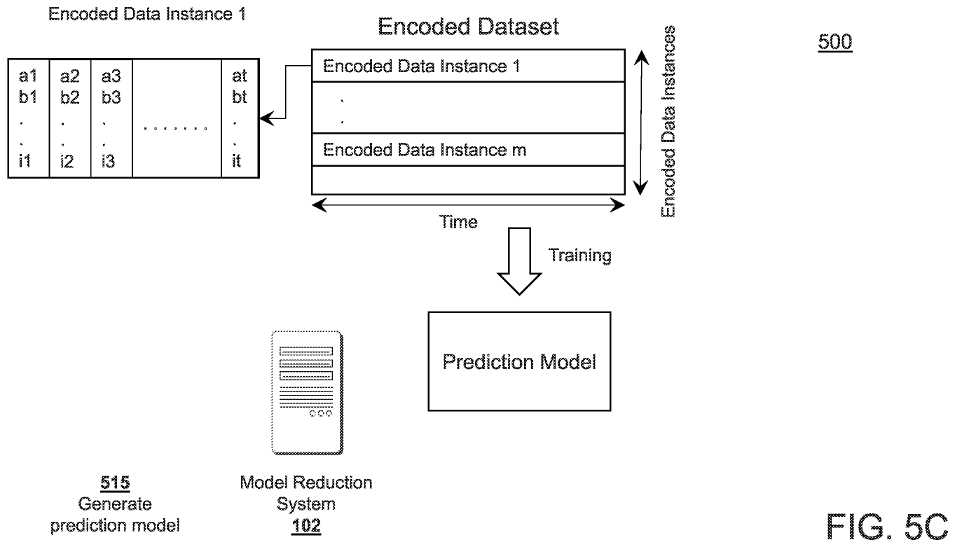

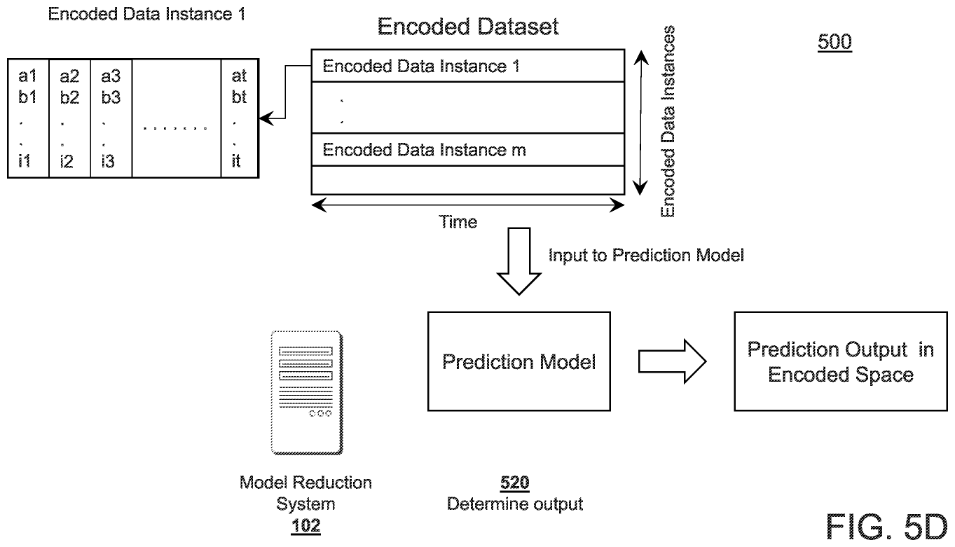

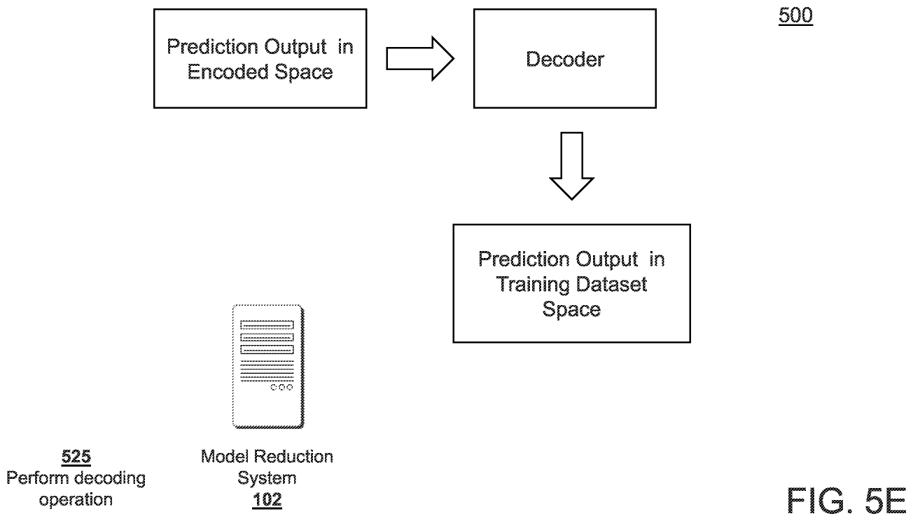

Referring now to FIGS. 5A-5E, FIGS. 5A-5E are diagrams of non-limiting embodiments or aspects of an implementation 500 of a process (e.g., process 300 and/or process 400) for generating a machine learning model and/or a prediction based on encoded time series data using model reduction techniques.

As shown by reference number 505 in FIG. 5A, model reduction system 102 may receive a training dataset. In some non-limiting embodiments or aspects, model reduction system 102 may receive a training dataset of a plurality of data instances. In some non-limiting embodiments or aspects, a data instance may correspond to a data source (e.g., issuer, bank, merchant, and/or the like). In some non-limiting embodiments or aspects, each data instance of the plurality of data instances may include a time series of data vectors and/or data points. For example, a data instance corresponding to an issuer may include a time series of data vectors including a transaction amount, PAN, and/or the like.

As shown by reference number 510 in FIG. 5B, model reduction system 102 may perform an encoding operation. In some non-limiting embodiments or aspects, model reduction system 102 may perform an encoding operation on a training dataset and/or an input dataset to provide an encoded dataset having a lower dimension space than a dimension space of the training dataset and/or input dataset. In some non-limiting embodiments or aspects, the lower dimension space may have a first dimension and a second dimension. In some non-limiting embodiments or aspects, the dimension space of the training dataset may have a first dimension and a second dimension. In some non-limiting embodiments or aspects, the first dimension of the lower dimension space may be less than the first dimension of the training dataset and the second dimension of the lower dimension space may be equal to the second dimension of the training dataset.

In some non-limiting embodiments or aspects, model reduction system 102 may provide the training dataset and/or input dataset to an encoder to perform the encoding operation. In some non-limiting embodiments or aspects, model reduction system 102 may generate the encoded dataset based on the training dataset and/or input dataset. In some non-limiting embodiments or aspects, the encoded dataset may include a plurality of data instances. In some non-limiting embodiments or aspects, each data instance of the plurality of data instances may include a time series of data vectors and/or data points. The encoded dataset may include a dataset having a lower dimension space than a dimension space of the training dataset and/or input dataset.

In some non-limiting embodiments or aspects, when performing the encoding operation on the dataset to provide the encoded dataset, model reduction system 102 may perform a factorization operation based on the optimization problem as provided herein. In some non-limiting embodiments or aspects, when performing the factorization operation, model reduction system 102 may update the projection matrix using a least square optimization problem. In some non-limiting embodiments or aspects, when performing the factorization operation, model reduction system 102 may update the transferred low-dimensional space using a graph-regularized alternating least squares (GRALS). In some non-limiting embodiments or aspects, when performing the factorization operation, model reduction system 102 may update the auto-regression model by solving expressions as provided herein.

As shown by reference number 515 in FIG. 5C, model reduction system 102 may generate a prediction model. In some non-limiting embodiments or aspects, model reduction system 102 may generate one or more prediction models based on the encoded dataset. In some non-limiting embodiments or aspects, when generating the one or more prediction models based on the encoded dataset, model reduction system 102 may train the one or more prediction models in the lower dimension space based on the encoded dataset. In some non-limiting embodiments or aspects, model reduction system 102 may generate a prediction model using the entire encoded dataset as training data. In some non-limiting embodiments or aspects, model reduction system 102 may generate one or more prediction models based on separate encoded data instances (e.g., one encoded data instance per prediction model, etc.). In some non-limiting embodiments or aspects, the one or more prediction models may include a number of prediction models. In some non-limiting embodiments or aspects, the number of prediction models may be equal to the first dimension of the lower dimension space.

As shown by reference number 520 in FIG. 5D, model reduction system 102 may determine an output. In some non-limiting embodiments or aspects, model reduction system 102 may determine an output of the one or more prediction models in the lower dimension space based on an input provided to the one or more prediction models. In some non-limiting embodiments or aspects, the input provided to the one or more prediction models may include data that was not used for training the one or more prediction models (e.g., new data, unseen data, and/or the like). In some non-limiting embodiments or aspects, model reduction system 102 may store the output of the one or more prediction models for future training.

As shown by reference number 525 in FIG. 5E, model reduction system 102 may perform a decoding operation. In some non-limiting embodiments or aspects, model reduction system 102 may perform a decoding operation on the output to project the output from the lower dimension space to the dimension space of the training dataset. In some non-limiting embodiments or aspects, model reduction system 102 may provide the output to a decoder to perform the decoding operation. In some non-limiting embodiments or aspects, model reduction system 102 may generate the decoded prediction based on the encoded dataset.

Although the above methods, systems, and computer program products have been described in detail for the purpose of illustration based on what is currently considered to be the most practical and preferred embodiments or aspects, it is to be understood that such detail is solely for that purpose and that the present disclosure is not limited to the described embodiments but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A system for generating a machine learning model based on encoded time series data using model reduction techniques, the system comprising:
at least one processor programmed or configured to:
receive a training dataset of a plurality of data instances, wherein each data instance comprises a time series of data points;
perform an encoding operation on the training dataset to provide an encoded dataset having a lower dimension space than a dimension space of the training dataset;
generate one or more prediction models based on the encoded dataset, wherein the one or more prediction models are configured to provide an output in the lower dimension space;
determine an output of the one or more prediction models in the lower dimension space based on an input provided to the one or more prediction models; and
perform a decoding operation on the output to project the output from the lower dimension space to the dimension space of the training dataset.

2. The system of claim 1, wherein, when generating the one or more prediction models based on the encoded dataset, the at least one processor is programmed or configured to:
train the one or more prediction models in the lower dimension space based on the encoded dataset.

3. The system of claim 1, wherein, when performing the encoding operation on the training dataset to provide the encoded dataset, the at least one processor is further programmed or configured to:
perform a factorization operation based on an optimization problem, wherein the optimization problem is the following:
$${min}_{F , X , W} {\sum }_{( i , t ) ∈ Ω} {( {Y}_{it} - {f}_{i}^{T} {x}_{t} )}^{2} + {λ}_{f} {ℛ}_{f} ( F ) + {\sum }_{r = 1}^{k} {λ}_{x} {𝒯}_{AR} ( {\overline{x}}_{r} \vert ℒ , {\overline{𝓌}}_{r} , η ) + {λ}_{w} {ℛ}_{w} ( 𝒲 ) ,$$
$$wherein :$$
$${𝒯}_{AR} ( \overline{x} \vert ℒ , \overline{ω} , η ) = \frac{1}{2} {\sum }_{t = m}^{T} {( {x}_{t} - {\sum }_{l ∈ ℒ} {ω}_{l} {x}_{t - l} )}^{2} + \frac{η}{2} {‖ \overline{x} ‖}^{2} ,$$
and
wherein:
xₜ=Σ_{l∈} [symbol] W^{(l)}xₜ₋ₗ+ϵₜ
wherein Yᵢₜ is the training dataset, i is an i-th observation target, t is a time stamp of each data point of the time series of data points, F is a projection matrix, fᵢ^{T} is a translation to an i-th row of the projection matrix F, X is the encoded dataset having a lower dimension space, xₜ is a data point of the time series of data points, k is a first dimension of the encoded dataset X, [symbol] _{f}(F) is a squared Frobenius norm of the projection matrix F, λ_{f} is a weight of the projection matrix F, W is an auto-regression model, [symbol] _{w}(W) is a squared Frobenius norm of the auto-regression model W, λ_{w} is a weight of the auto-regression model W, [symbol] is a score of the auto-regression model W, λₓ is a weight of the score of the auto-regression model [symbol] , [symbol] is a second dimension of the encoded dataset X, w is a prediction model, η is a weight to a vector norm, l is an individual component of the second dimension [symbol] , T is a total time of the of the time series of data points, and ϵₜ is an error value associated with xₜ.

4. The system of claim 3, wherein, when performing the factorization operation, the at least one processor is programmed or configured to:
update the projection matrix F using a least square optimization problem;
update the transferred low-dimensional space X using a graph-regularized alternating least squares (GRALS); and
update the auto-regression model [symbol] by solving the following:
$$arg {min}_{\overline{ω}} {λ}_{x} {𝒯}_{AR} ( {\overline{x}}_{r} \vert ℒ , \overline{ω} , η ) + {λ}_{w} {‖ \overline{ω} ‖}^{2} = arg {min}_{\overline{ω}} {\sum }_{t = m}^{T} {( {x}_{t} - {\sum }_{l ∈ ℒ} {ω}_{l} {x}_{t - l} )}^{2} + \frac{{λ}_{w}}{{λ}_{x}} {‖ \overline{ω} ‖}^{2} .$$

5. The system of claim 3, wherein, when performing the decoding operation on the output to project the output from the lower dimension space to the dimension space of the training dataset, the at least one processor is programmed or configured to:
project the output from the lower dimension space to the dimension space of the training dataset using an inverse of the projection matrix F.

6. The system of claim 1, wherein the lower dimension space has a first dimension and a second dimension, and wherein the dimension space of the training dataset has a first dimension and a second dimension, wherein the first dimension of the lower dimension space is less than the first dimension of the training dataset, and wherein the second dimension of the lower dimension space is equal to the second dimension of the training dataset.

7. The system of claim 6, wherein the one or more prediction models comprise a number of prediction models, and wherein the number of prediction models is equal to the first dimension of the lower dimension space.

8. A method for generating a machine learning model based on encoded time series data using model reduction techniques, the method comprising:
receiving, with at least one processor, a training dataset of a plurality of data instances, wherein each data instance comprises a time series of data points;
performing, with the at least one processor, an encoding operation on the training dataset to provide an encoded dataset having a lower dimension space than a dimension space of the training dataset;
generating, with the at least one processor, one or more prediction models based on the encoded dataset, wherein the one or more prediction models are configured to provide an output in the lower dimension space;
determining, with the at least one processor, an output of the one or more prediction models in the lower dimension space based on an input provided to the one or more prediction models; and
performing, with the at least one processor, a decoding operation on the output to project the output from the lower dimension space to the dimension space of the training dataset.

9. The method of claim 8, wherein generating the one or more prediction models based on the encoded dataset comprises:
training the one or more prediction models in the lower dimension space based on the encoded dataset.

10. The method of claim 8, wherein performing the encoding operation on the training dataset to provide the encoded dataset comprises:
performing a factorization operation based on an optimization problem, wherein the optimization problem is the following:
$${min}_{F , X , W} {\sum }_{( i , t ) ∈ Ω} {( {Y}_{it} - {f}_{i}^{T} {x}_{t} )}^{2} + {λ}_{f} {ℛ}_{f} ( F ) + {\sum }_{r = 1}^{k} {λ}_{x} {𝒯}_{AR} ( {\overline{x}}_{r} \vert ℒ , {\overline{𝓌}}_{r} , η ) + {λ}_{w} {ℛ}_{w} ( 𝒲 ) ,$$
$$wherein :$$
$${𝒯}_{AR} ( \overline{x} \vert ℒ , \overline{ω} , η ) = \frac{1}{2} {\sum }_{t = m}^{T} {( {x}_{t} - {\sum }_{l ∈ ℒ} {ω}_{l} {x}_{t - l} )}^{2} + \frac{η}{2} {‖ \overline{x} ‖}^{2} ,$$
and
wherein:
xₜ= [symbol] W^{(l)}xₜ₋ₗ+ϵₜ
wherein Yᵢₜ is the training dataset, i is an i-th observation target, t is a time stamp of each data point of the time series of data points, F is a projection matrix, fᵢ^{T} is a translation to an i-th row of the projection matrix F, X is the encoded dataset having a lower dimension space, xₜ is a data point of the time series of data points, k is a first dimension of the encoded dataset X, [symbol] _{f}(F) is a squared Frobenius norm of the projection matrix F, λ_{f} is a weight of the projection matrix F, W is an auto-regression model, [symbol] _{w}(W) is a squared Frobenius norm of the auto-regression model W, λ_{W} is a weight of the auto-regression model W, [symbol] is a score of the auto-regression model W, λₓ is a weight of the score of the auto-regression model [symbol] , [symbol] is a second dimension of the encoded dataset X, w is a prediction model, η is a weight to a vector norm, l is an individual component of the second dimension [symbol] , T is a total time of the of the time series of data points, and ϵₜ is an error value associated with xₜ.

11. The method of claim 10, wherein performing the factorization operation comprises:
updating the projection matrix F using a least square optimization problem;
updating the transferred low-dimensional space X using a graph-regularized alternating least squares (GRALS); and
updating the auto-regression model [symbol] by solving the following:
$$arg {min}_{\overline{ω}} {λ}_{x} {𝒯}_{AR} ( {\overline{x}}_{r} \vert ℒ , \overline{ω} , η ) + {λ}_{w} {‖ \overline{ω} ‖}^{2} = arg {min}_{\overline{ω}} {\sum }_{t = m}^{T} {( {x}_{t} - {\sum }_{l ∈ ℒ} {ω}_{l} {x}_{t - l} )}^{2} + \frac{{λ}_{w}}{{λ}_{x}} {‖ \overline{ω} ‖}^{2} .$$

12. The method of claim 10, wherein performing the decoding operation on the output to project the output from the lower dimension space to the dimension space of the training dataset comprises:
projecting the output from the lower dimension space to the dimension space of the training dataset using an inverse of the projection matrix F.

13. The method of claim 8, wherein the lower dimension space has a first dimension and a second dimension, and wherein the dimension space of the training dataset has a first dimension and a second dimension, wherein the first dimension of the lower dimension space is less than the first dimension of the training dataset, and wherein the second dimension of the lower dimension space is equal to the second dimension of the training dataset.

14. The method of claim 13, wherein the one or more prediction models comprise a number of prediction models, and wherein the number of prediction models is equal to the first dimension of the lower dimension space.

15. A computer program product for generating a machine learning model based on encoded time series data using model reduction techniques, the computer program product comprising at least one non-transitory computer-readable medium including one or more instructions that, when executed by at least one processor, cause the at least one processor to:
receive a training dataset of a plurality of data instances, wherein each data instance comprises a time series of data points;
perform an encoding operation on the training dataset to provide an encoded dataset having a lower dimension space than a dimension space of the training dataset;
generate one or more prediction models based on the encoded dataset, wherein the one or more prediction models are configured to provide an output in the lower dimension space;
determine an output of the one or more prediction models in the lower dimension space based on an input provided to the one or more prediction models; and
perform a decoding operation on the output to project the output from the lower dimension space to the dimension space of the training dataset.

16. The computer program product of claim 15, wherein the one or more instructions that cause the at least one processor to generate the one or more prediction models based on the encoded dataset cause the at least one processor to:
train the one or more prediction models in the lower dimension space based on the encoded dataset.

17. The computer program product of claim 15, wherein the one or more instructions that cause the at least one processor to perform the encoding operation on the training dataset to provide the encoded dataset cause the at least one processor to:
perform a factorization operation based on an optimization problem, wherein the optimization problem is the following:
$${min}_{F , X , W} {\sum }_{( i , t ) ∈ Ω} {( {Y}_{it} - {f}_{i}^{T} {x}_{t} )}^{2} + {λ}_{f} {ℛ}_{f} ( F ) + {\sum }_{r = 1}^{k} {λ}_{x} {𝒯}_{AR} ( {\overline{x}}_{r} \vert ℒ , {\overline{𝓌}}_{r} , η ) + {λ}_{w} {ℛ}_{w} ( 𝒲 ) ,$$
$$wherein :$$
$${𝒯}_{AR} ( \overline{x} \vert ℒ , \overline{ω} , η ) = \frac{1}{2} {\sum }_{t = m}^{T} {( {x}_{t} - {\sum }_{l ∈ ℒ} {ω}_{l} {x}_{t - l} )}^{2} + \frac{η}{2} {‖ \overline{x} ‖}^{2} ,$$
and
wherein:
xₜ= [symbol] W^{(l)}xₜ₋ₗ+ϵₜ
wherein Yᵢₜ is the training dataset, i is an i-th observation target, t is a time stamp of each data point of the time series of data points, F is a projection matrix, fᵢ^{T} is a translation to an i-th row of the projection matrix F, X is the encoded dataset having a lower dimension space, xₜ is a data point of the time series of data points, k is a first dimension of the encoded dataset X, [symbol] _{f}(F) is a squared Frobenius norm of the projection matrix F, λ_{f} is a weight of the projection matrix F, W is an auto-regression model, [symbol] _{w}(W) is a squared Frobenius norm of the auto-regression model W, λ_{w} is a weight of the auto-regression model W, [symbol] is a score of the auto-regression model W, λₓ is a weight of the score of the auto-regression model [symbol] , [symbol] is a second dimension of the encoded dataset X, w is a prediction model, η is a weight to a vector norm, l is an individual component of the second dimension [symbol] , T is a total time of the of the time series of data points, and ϵₜ is an error value associated with xₜ.

18. The computer program product of claim 17, wherein the one or more instructions that cause the at least one processor to perform the factorization operation cause the at least one processor to:
update the projection matrix F using a least square optimization problem;
update the transferred low-dimensional space X using a graph-regularized alternating least squares (GRALS); and
update the auto-regression model [symbol] by solving the following:
$$arg {min}_{\overline{ω}} {λ}_{x} {𝒯}_{AR} ( {\overline{x}}_{r} \vert ℒ , \overline{ω} , η ) + {λ}_{w} {‖ \overline{ω} ‖}^{2} = arg {min}_{\overline{ω}} {\sum }_{t = m}^{T} {( {x}_{t} - {\sum }_{l ∈ ℒ} {ω}_{l} {x}_{t - l} )}^{2} + \frac{{λ}_{w}}{{λ}_{x}} {‖ \overline{ω} ‖}^{2} .$$

19. The computer program product of claim 17, wherein the one or more instructions that cause the at least one processor to perform the decoding operation on the output to project the output from the lower dimension space to the dimension space of the training dataset cause the at least one processor to:
project the output from the lower dimension space to the dimension space of the training dataset using an inverse of the projection matrix F.

20. The computer program product of claim 15, wherein the lower dimension space has a first dimension and a second dimension, and wherein the dimension space of the training dataset has a first dimension and a second dimension, wherein the first dimension of the lower dimension space is less than the first dimension of the training dataset, and wherein the second dimension of the lower dimension space is equal to the second dimension of the training dataset.
